(19) United States
(12) Patent Application Publication
(10) Pub. No.: US 2003/0005009 A1
(43) Pub. Date: Jan. 2, 2003

(54) Least-mean square system with adaptive step size

(76) Inventor: Mohammad Usman, Mission Viejo, CA (US)

Correspondence Address: PATENT METRIX, LLC, 14252 CULVER DR. #914, IRVINE, CA, 92604, US

(21) Appl. No.: 09/837,866

(22) Filed: Apr. 17, 2001

(51) Int. Cl. G06F 17/10

(52) U.S. Cl. 708/322

(57) ABSTRACT

An adaptive filter based on a recursive algorithm with an adaptive step size is described. The recursive algorithm provides relatively fast convergence without undue computational overhead. In one embodiment, the recursive algorithm has an update similar to LMS where a first gradient is used to compute new filter weights using an adaptation factor. The adaptation factor is computed at each step using one or more estimated gradients. In one embodiment, the gradients are estimated in a region near the current set of filter weights. In one embodiment, the adaptive filter algorithm is used in an echo canceller to reduce the effect of line echo in a modem.

### BACKGROUND OF THE INVENTION

1. Field of the Invention

The invention relates to adaptive filters using a Least-Mean-Square (LMS) optimization with an adaptive step size.

2. Description of the Related Art

The term “filter” is often used to describe a signal processing element (hardware or software) that accepts an input signal having desired and undesired components, and that produces an output signal where the undesired components have been wholly or partially removed. Thus, for example, a filter can remove unwanted frequency content, noise, etc. from the input signal. Filters can be classified as linear and nonlinear. A filter is said to be linear of the output signal can be described as is a linear function of the input signal. Otherwise, the filter is nonlinear.

The design of filters is often approached as an optimization problem. A useful approach to this filter optimization problem is to minimize the mean-square value of an error signal that is defined as the difference between some desired response and the actual filter output. For stationary inputs, the resulting solution is commonly known as the Wiener filter, which is said to be optimum in the mean-square sense. The Weiner filter is inadequate for dealing with situations in which the nonstationary nature of the signal and/or noise is intrinsic to the filter problem. In such situations, the optimum filter has to assume a time-varying form.

The design of a Weiner filter requires a priori information about the statistics of the data to be processed. This filter is optimum only when the statistical characteristics of the input data mach the a priori information on which the design of the filter is based. When this information is not known completely, however, it may not be possible to design the Wiener filter or else the design may no longer be optimum. When the data to be processed is nonstationary, the Wiener filter is typically replaced by an adaptive filter.

An adaptive filter is self-designing in that the adaptive filter relies for its operation on a recursive algorithm, which makes it possible for the filter to perform satisfactorily in an environment where complete knowledge of the relevant signal characteristics is not available. The Least-Mean-Square (LMS) type of recursive algorithm often used in adaptive filters often suffer from problems related to slow convergence. The Conjugate Gradient (CG) type of recursive algorithm often used in adaptive filters offer better convergence than the LMS algorithm, but consumes far more computing resources.

### SUMMARY OF THE INVENTION

The present invention solves these and other problems by providing a recursive algorithm that provides relatively fast convergence with a relatively light computational burden. In one embodiment, a combined LMS/CG algorithm provides relatively fast convergence with a relatively light computational burden. In one embodiment, the combined LMS/CG algorithm has an update similar to LMS where a first gradient is used to compute new filter weights using an adaptation factor, and like CG, the adaptation factor is computed at each step using one or more gradients or estimated gradients.

In one embodiment, the LMS/CG algorithm is used in an echo canceller to reduce the effect of line echo in a modem.

### BRIEF DESCRIPTION OF THE DRAWINGS

Aspects, features, and advantages of the present invention will be more apparent from the following particular description thereof presented in conjunction with the following drawings, wherein:

FIG. 1 is a block diagram of an adaptive filter

FIG. 2 is a block diagram of a communication system that uses adaptive filters for echo cancellation.

FIG. 3 is a functional block diagram of an adaptive filter algorithm that uses an adaptive step size.

In the drawings, the first digit of any three-digit reference number generally indicates the number of the figure in which the referenced element first appears

### DETAILED DESCRIPTION OF THE PREFERRED EMBODIMENT

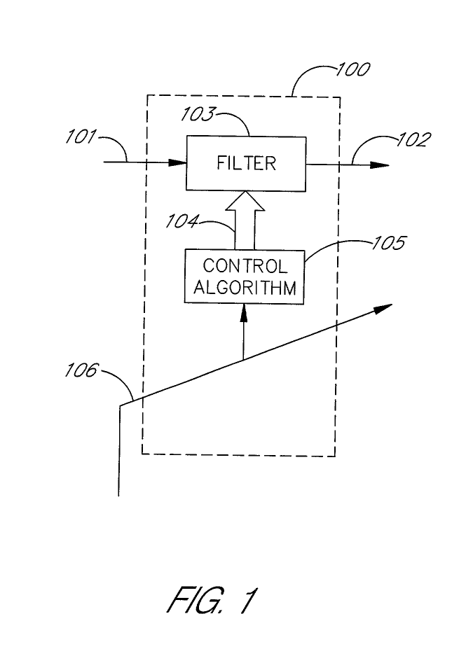

An adaptive filter is a self-designing filter that uses a algorithm, typically a recursive algorithm, to adjust the filter characteristics. The ability to change filter characteristics makes it possible for the adaptive filter to perform satisfactorily in an environment where complete knowledge of the relevant signal characteristics is not available. FIG. 1 is a block diagram of an adaptive filter 100. The adaptive filter 100 has a filter input 101, a filter output 102, and an error signal input 106. The filter input 101 is provided to an input of a filter 103, and an output of the filter 103 is provided to the filter output 102. The error signal 106 is provided to an input of a control algorithm 105. Filter configuration data 104 is computed by the control algorithm 105 and provided to a control input of the filter 103. The filter 103 can be an analog filter, a digital filter, or a combination thereof. The configuration data 104 specifies, at least in part, the transfer function of the filter 103. For example, if the filter 103 is a digital filter, such as a Finite Impulse Response (FIR) filter or an Infinite Impulse Response (IIR) filter, the configuration data 104 includes a set of weights that determine the transfer function of the filter 103.

The control algorithm 105 computes the configuration data 104 from the error signal by using a control algorithm. The control algorithm is typically a recursive algorithm. The algorithm starts from some predetermined set of initial conditions, representing whatever is known about the environment, and attempts to configure the filter 103 to minimize the error signal in some mean-squared sense. In a stationary environment, the control algorithm converges to the optimum Wiener solution. In a nonstationary environment, the algorithm offers a tracking capability, in that it can track time variations in the statistics of the input data, provided that the variations are sufficiently slow.

As a direct consequence of the application of a recursive algorithm whereby the parameters of an adaptive filter are updated from one iteration to the next, the transfer function of the filter 103 becomes time-dependent. This, therefore, means that an adaptive filter is, in reality, a nonlinear device in the sense that it does not obey the principle of superposition. Notwithstanding this property, adaptive filters are commonly classified as linear or nonlinear. An adaptive filter is said to be linear if the estimate of a quantity of interest is computed adaptively at the filter output 102 as a linear combination of the available set of observations applied to the filter input 101 for a given set of configuration data 104. In other words, the adaptive filter 100 is said to be linear if, for a given set of configuration data 104, the output 102 is linearly related to the input 101. Otherwise, the adaptive filter is said to be nonlinear.

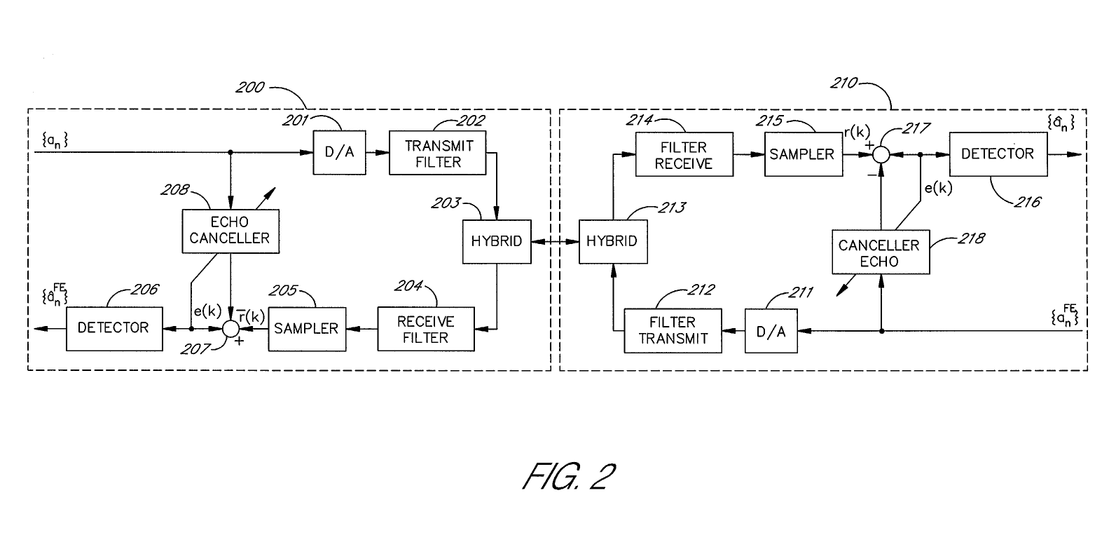

There always exist trade-offs between speed of convergence, stability, and performance of an adaptive filter. While stability of an algorithm is an important consideration, it is also typically important that the algorithm has fast convergence and high SNR. This is important in modems (such as the modems shown in FIG. 2) where only a certain amount of time, and therefore number of samples of training data, are available during which convergence should be achieved.

The choice of the control algorithm 105 is based, at least in part, on issues relating to rate of convergence, tracking, robustness, computational requirements, and numerical properties. Rate of convergence is defined as the number of iterations required for the control algorithm 105, in response to stationary inputs, to converge (at least approximately) to the optimum Wiener solution in the mean-square sense. A fast rate of convergence allows the control algorithm 105 to adapt rapidly to a stationary environment of unknown statistics.

When the adaptive filter 100 operates in a nonstationary environment, the control algorithm 105 is required to track statistical variations in the environment. The tracking performance of the control algorithm 105, however, is influenced by two contradictory features: (1) the rate of convergence, and (2) steady-state fluctuation due to algorithm noise.

If the adaptive filter 100 is robust, then small disturbances (i.e. disturbances with small energy) can only result in small errors in the control algorithm 105. The disturbances can arise from factors external to the filter 100 and from factors internal to the filter 100.

The computational requirements of the control algorithm 105 include: (a) the number of operations (i.e. multiplications, divisions, additions, and subtractions) required to make one complete iteration of the algorithm; (b) the amount of memory needed to store the control algorithm program and its data; and (c) the engineering investment required to program the algorithm.

When the algorithm 105 is implemented digitally, inaccuracies are produced due to quantization errors. The quantization errors are due to analog-to-digital conversion of the input data and digital representation of internal calculations. In particular, there are two areas of concern: numerical stability and numerical accuracy. Numerical stability (or lack thereof) is an inherent characteristic of an adaptive filtering algorithm. Numerical accuracy, on the other hand, is determined by the word length used in the numerical calculations. An adaptive filtering algorithm is said to be numerically robust when it is relatively insensitive to variations in the word length used in its digital implementation.

The Least Mean-Squared (LMS) algorithm is widely used in applications such as the control algorithm 105 because of its simplicity and relatively light computational burden. However, the LMS algorithm has two major disadvantages. First, it requires specification of an adaptation coefficient, μ, which is typically given by the user and adjusted when close to convergence for a better Signal-to-Noise Ratio (SNR). Second, the LMS algorithm exhibits slow convergence. The parameter μ, which controls the speed of convergence, is usually found by trial-and-error methods. Although, an upper bound for μ can be computed, use of the upper bound does not guarantee the best possible convergence.

An alternative to the LMS is conjugate gradient (CG) method. For an n-dimensional problem (i.e., an n-tap filter) CG guarantees convergence in n steps given infinite precision. Unfortunately, the CG method requires specification of a matrix to be inverted. For most applications, this matrix is not easily specified and can only be estimated. For instance in modems, the matrix to be inverted is the auto-correlation matrix of the input data. Estimation of this matrix is not only computationally expensive, but it also affects the convergence properties of the CG method and frequently causes the algorithm to diverge.

In one embodiment, the control algorithm 105 is based on a modified algorithm that uses the best properties of the CG method and the LMS method. The modified algorithm avoids an explicit specification of μ by using a CG-like step, but the modified algorithm uses an LMS-like update procedure to avoid the need for a CG matrix. Since the modified algorithm is based on properties of the LMS method and the CG method, it is useful to first develop expressions for both of these methods.

In the LMS method, given an input vector \overline{u}, and a vector of filter coefficients or weights, \overline{w} then the minimum mean-squared error function can be written as:

J(\overline{w})=σ_{d}²−\overline{w}^{H}\overline{p}−\overline{p}^{H}\overline{w}+R\overline{w},

where σ_{d}² is the variance of the desired signal d(k), R is the auto-correlation matrix of the input signal \overline{u}, and \overline{p} is the cross-correlation between the desired signal d(k) and input \overline{u}.

The minimum value of J(\overline{w}) is:

$${min}_{\overline{ω}} J ( \overline{w} ) = {σ}_{d}^{2} - {\overline{p}}^{H} R \overline{p}$$

for

\overline{w}ₒₚₜᵢₘₐₗ=R⁻¹\overline{p}.

Here, \overline{w}ₒₚₜᵢₘₐₗ are the optimal weight of the filter in mean-squared sense. In LMS, the following update is used for the filter weights:

$${\overline{w}}_{n + 1} = {\overline{w}}_{n} + \frac{μ}{2} ∇ J , \qquad ( 1 )$$

where ∇J is the gradient of J:

$$∇ J = 2 E [ {\overline{u}}_{k}^{H} \{ d ( k ) - {\overline{w}}_{k}^{T} {\overline{u}}_{k} \} ] ,$$

where E denotes a statistical expectation. The term in braces in the above equation is the error between the desired and estimated signal, which can be defined as:

$$e ( k ) = ( d ( k ) - {\overline{w}}_{k}^{T} {\overline{u}}_{k} )$$

In LMS, the statistical expectation is estimated by the instantaneous value of the gradient. Therefore:

\overline{w}ₖ₊₁=\overline{w}ₖ+μe(n) \overline{u}ₖ, (2)

It has been shown that the proper choice of μ should be:

$$0 < μ < \frac{2}{{λ}_{max}} ,$$

where μₘₐₓ is the maximum eigenvalue of the auto-correlation matrix R. Since R is not known and, therefore, μₘₐₓ is not known, one cannot necessarily choose a good value of μ. In practice, a value for μ is usually chosen by trial-and-error. The value of μ affects the filter performance. Smaller values of μ give higher signal-to-noise ratio but take more time to converge. Usually, a designer starts with a relatively large value of μ for fast initial convergence, and then chooses a smaller value for high SNR.

Conjugate gradient methods are computationally more expensive than LMS methods, but converge much faster. Conjugate gradient methods have been formulated for a purely quadratic problem as follows:

$${min}_{\overline{ω}} ( \frac{1}{2} {\overline{w}}^{H} R \overline{w} - {\overline{p}}^{T} \overline{w} ) , \qquad ( 3 )$$

where R is a positive definite matrix. To find the above minimum, take the gradient with respect to \overline{w}:

∇f(\overline{w})=R\overline{w}−\overline{p}=0

R\overline{w}=\overline{p}.

Therefore, finding the minimum of equation (3) is equivalent to solving R\overline{w}=\overline{p}. To solve this equation, find direction vectors \overline{d} and step size a such that \overline{d}ᵢ, is R-conjugate to \overline{d}ⱼ, i≠j. R-conjugate is defined as:

\overline{d}ᵢ^{T}R\overline{d}ⱼ=0, i≠j. (4)

If the condition in equation (4) is fulfilled, then for an n-dimensional system the optimal solution that satisfies (3) is:

\overline{w}ₒₚₜᵢₘₐₗ=α₀\overline{d}₀+α₁\overline{d}₁+ . . . ααₙ₋₁\overline{d}ₙ₋₁.

This implies that, given infinite precision, CG is guaranteed to converge within n iterations. There are, however, some problems. First, infinite precision is not available on computers. This becomes an issue when R is ill conditioned or has a high condition number. Second, the standard CG algorithm is applied to quadratic problems. A more general algorithm would also treat non-quadratic problems. Finally, in many circumstances, R is not given and needs to be estimated. If the estimate for R is poor, then the system is typically unstable and will fail to converge.

The conjugate gradient algorithm for a general non-quadratic problem can be derived by using quadratic method or the method of Fletcher-Reeves, but these require knowledge of the Hessian of the functional f(\overline{w}) at \overline{w}k. The functional f(\overline{w}) is given by:

$$f ( \overline{w} ) = ( \frac{1}{2} {\overline{w}}^{H} R \overline{w} - {\overline{p}}^{T} \overline{w} ) .$$

An alternate technique is to solve the general problem that does not require computation of the Hessian as follows.

Given gₖ=∇f^{T}(\overline{w}ₖ), it can be shown that \overline{d}ₖ^{T} R\overline{d}ₖ=\overline{d}ₖ^{T} R\overline{g}ₖ. Therefore, in order to obtain \overline{w}ₖ₊₁ from \overline{w}ₖ one only needs to use R to evaluate \overline{g} and R\overline{g}ₖ.

To evaluate R\overline{g}ₖ, assume that the problem is quadratic, and take a unit from \overline{w} step in the direction of the negative gradient and evaluate the function at that point. Therefore, let:

\overline{y}ₖ=\overline{w}ₖ−\overline{g}ₖ,

from which,

\overline{g}ₖ=∇f^{T}(\overline{w}ₖ)=R\overline{w}ₖ−\overline{p}

Define \overline{h} as:

\overline{h}ₖ=∇f^{T}(\overline{y}ₖ)=R\overline{y}ₖ−\overline{p}

It follows from the above equations that:

$$\begin{matrix}{\overline{h}}_{k} = R {\overline{y}}_{k} - \overline{p} \\ = R {\overline{w}}_{k} - R {\overline{g}}_{k} - \overline{p} \\ = {\overline{g}}_{k} - R {\overline{g}}_{k} .\end{matrix}$$

Hence,

R\overline{g}ₖ=\overline{w}ₖ−\overline{h}ₖ

Given the above equation, a modified CG algorithm that does not require knowledge of a Hessian or a line search is given below. Step 1:

Starting with any value of \overline{w}₀ compute:

\overline{g}₀=∇f ^{T}(\overline{w}₀)

\overline{y}₀=\overline{ω}₀−\overline{g}₀

\overline{h}₀=∇f^{T}(\overline{y}₀)

\overline{d}₀=−\overline{g}₀

Step 2:

For k=0, 1, . . . , n−1 do

$$\begin{matrix}{α}_{k} = \frac{{\overline{g}}_{k}^{T} {\overline{d}}_{k}}{{\overline{d}}_{k}^{T} ( {\overline{g}}_{k} - {\overline{h}}_{k} )} \\ {\overline{w}}_{k + 1} = {\overline{w}}_{k} + {α}_{k} {\overline{d}}_{k} \\ {\overline{g}}_{k + 1} = ∇ {f}^{T} {\overline{g}}_{k + 1} = \frac{2}{{n}_{w}} {\sum }_{j = k - {n}_{w} + 1}^{k} ( {\overline{w}}_{k}^{T} {\overline{u}}_{k} - r ( j ) ) \overline{u} ( j ) \\ {\overline{y}}_{k + 1} = {\overline{w}}_{k + 1} - {\overline{g}}_{k + 1} \\ {\overline{h}}_{k + 1} = ∇ {f}^{T} {\overline{y}}_{k + 1} = \frac{2}{{n}_{w}} {\sum }_{j = k - {n}_{w} + 1}^{k} ( {\overline{y}}_{k}^{T} {\overline{u}}_{k} - r ( j ) ) \overline{u} ( j ) \\ {β}_{k} = \frac{{\overline{g}}_{k + 1}^{T} {\overline{g}}_{k + 1}}{{\overline{g}}_{k}^{T} {\overline{g}}_{k}}\end{matrix}$$

if k≠n

\overline{d}ₖ₊₁=\overline{g}ₖ₊₁+βₖ\overline{d}ₖ

else

Replace \overline{ω}₀ with \overline{ω}(n) and go to Step 1 end for

Where n_{w} is the window size in number of sample points over which the gradient is estimated. Although, the above modified CG method takes care of some of the shortcomings of the original CG method, the modified CG method is often unstable in practice.

In one embodiment, the control algorithm 105 uses an LMS/CG algorithm that uses features from the LMS method and the modified CG method. The LMS/CG algorithm has an update similar to LMS where only the first gradient is used for weights update, and like CG, the adaptation factor, α, is computed at each step using both the gradients, \overline{g}, and \overline{h}. In the LMS/CG method, filter weights for the filter 103 are computed using the update:

\overline{w}ₖ₊₁=\overline{w}ₖ+αₖ\overline{g}ₖ

Note that the adaptation constant μ has been replaced by an adaptation factor αₖ. To compute αₖ, note that:

$${\overline{g}}_{k} = ∇ J = - 2 [ r ( k ) - {\overline{w}}_{k}^{T} {\overline{u}}_{k} ] {\overline{u}}^{H} ( k )$$

Similarly,

\overline{y}ₖ=\overline{w}ₖ−\overline{g}ₖ,

and,

$${\overline{h}}_{k} = ∇ {f}_{k}^{T} ( {\overline{y}}_{k} ) = - 2 [ r ( k ) - {\overline{y}}_{k}^{T} {\overline{u}}_{k} ] {\overline{u}}^{H} ( k ) \\ = - 2 [ r ( k ) - {( {\overline{w}}_{k} - {\overline{g}}_{k} )}^{T} {\overline{u}}_{k} ] {\overline{u}}^{H} ( k ) \\ = - 2 [ r ( k ) - {\overline{g}}_{k}^{T} {\overline{u}}_{k} ] {\overline{u}}^{H} ( k )$$

Where r(k) is a response signal that includes desired components and the error (or noise) components e(k) introduced by a system (e.g., a plant) associated with the adaptive filter. As in the method of steepest descent, only one gradient is used. However, the CG formulation allows the choice of a step size that is not a constant. This step size is optimal if the gradient and the conjugate directions are co-incident. After simple algebraic manipulation, it follows that:

$${α}_{k} = \frac{{\overline{g}}_{k}^{T} {\overline{g}}_{k}}{{\overline{g}}_{k}^{T} [ {\overline{g}}_{k} - {\overline{h}}_{k} ]} .$$

Here only the instantaneous estimates of the gradients, \overline{g}ₖ=∇f^{T}(\overline{w}) and \overline{h}=∇f^{T}(\overline{y}) have been used. The step size in the modified CG algorithm is chosen under the assumption that the direction vector \overline{d}ᵢ is R orthogonal to \overline{d}ₖ, for i≠k. In the LMS/CG algorithm, the conjugate directions are replaced with the gradients and, although \overline{g}ᵢ^{T}\overline{g}i+1=0, R-conjugation is not guaranteed. Therefore, the LMS/CG method does not guarantee convergence in n steps even if given infinite precision. On the other hand, since the step size is chosen under the assumption that all \overline{g}ᵢ are R-conjugate (and given enough iterations they will span the sub-space like \overline{d}i's) the behavior is typically similar to CG close to the point of convergence. In summary, this algorithm is typically behaves more like LMS initially and more like CG close to convergence.

The LMS/CG algorithm is as follows:

Step 1:

Start with any value of \overline{w}₀.

Step 2:

while e(k) is above a desired threshold:

e(k)=r(k)−\overline{w}ₖ^{T}\overline{u}ₖ

\overline{g}ₖ=−2\overline{u}^{H}(k)e(k)

\overline{h}ₖ=−2(e(k)−\overline{g}ₖ^{T}\overline{u}ₖ)\overline{u}ₖ^{H}

$${α}_{k} = \frac{{\overline{g}}_{k}^{T} {\overline{g}}_{k}}{{\overline{g}}_{k}^{T} ( {\overline{g}}_{k} - {\overline{h}}_{k} )}$$

$${\overline{w}}_{k + 1} = {\overline{w}}_{k} + {α}_{k} {\overline{g}}_{k}$$

end while

Adaptive filtering algorithms are commonly used in modems for echo cancellation and equalization. FIG. 2 is a block diagram showing a modem 200 and a modem 210. The modems 200 and 210 use adaptive filters for echo cancellation.

In the modem 200, data to be transmitted is provided to an input of a digital to analog converter 201 and to a filter data input of an echo canceller 208. An output of the digital to analog converter 201 is provided to an input of a transmit filter 202. An output of the transmit filter 202 is provided to a data input of a hybrid 203. An output of the hybrid 203 is provided to an input of a receive filter 204. An output of the receive filter 204 is provided to an input of a sampler (i.e., an analog to digital converter) 205. A digital output from the sampler 205 is provided to a non-inverting input of an adder 207. A filter data output from the echo canceller 208 is provided to an inverting input of the adder 207. An output of the adder 208 is provided to an error signal input of the echo canceller 208 and to a detector 206. The output from the adder 208 is the difference between the output of the sampler 205 and the output of the echo canceller 208.

In the modem 210, data to be transmitted is provided to an input of a digital to analog converter 211 and to a filter data input of an echo canceller 218. An output of the digital to analog converter 211 is provided to an input of a transmit filter 212. An output of the transmit filter 212 is provided to a data input of a hybrid 213. An output of the hybrid 213 is provided to an input of a receive filter 214. An output of the receive filter 214 is provided to an input of a sampler (i.e., an analog to digital converter) 215. A digital output from the sampler 215 is provided to a non-inverting input of an adder 217. A filter data output from the echo canceller 218 is provided to an inverting input of the adder 217. An output of the adder 218 is provided to an error signal input of the echo canceller 218 and to a detector 216. The output from the adder 218 is the difference between the output of the sampler 215 and the output of the echo canceller 208. A line input/output port of the hybrid 203 is provided to a line input/output port of the hybrid 213. The echo cancellers 208 and 218 are adaptive filters that provide an echo cancelling signal to the adders 207 and 217 respectively.

Only minor modifications are needed for the LMS/CG algorithm to be applicable to be used in echo cancellation. Since the received signal in the modems 200 and 210 is real, the following algorithm is used in the echo cancellers 208 and 218:

Step 1:

Start with any value of \overline{w}₀.

Step 2:

while e(k) is above a given threshold:

$$\\ e ( k ) = Re [ r ( k ) - {\overline{w}}_{k}^{T} {\overline{u}}_{k} ]$$

\overline{g}ₖ=−2\overline{u}*(k)e(k)

\overline{h}ₖ=−2(e(k)−\overline{g}ₖ^{T}\overline{u}ₖ)\overline{u}ₖ*

$${α}_{k} = \frac{{\overline{g}}_{k}^{T} {\overline{g}}_{k}}{{\overline{g}}_{k}^{T} ( {\overline{g}}_{k} - {\overline{h}}_{k} )}$$

$${\overline{w}}_{k + 1} = {\overline{w}}_{k} + {α}_{k} {\overline{g}}_{k}$$

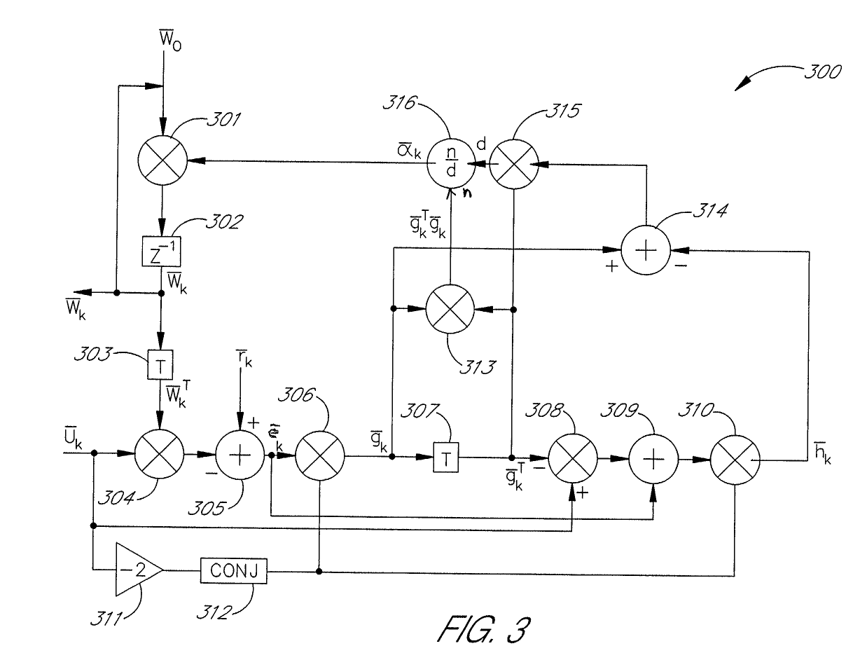

end while

Where Re denotes the real part of a complex number. An implementation of the above algorithm is shown in FIG. 3. In FIG. 3, a set (a vector) of starting weights \overline{w}₀ is provided to a first input of a multiplier 301. An output of the multiplier 301 is provided to an input of a time delay 302. An output of the time delay 302 is an updated set of weights \overline{w}ₖ. The output of the time delay 302 is provided to an input of a transpose block 303. An output of the transpose block 303 is provided to a first input of a multiplier 304. An input signal \overline{u}ₖ is provided to a second input of the multiplier 304, to an input of an amplifier 311, and to a first input of a multiplier 308. An output of the multiplier 304 is provided to an inverting input of an adder 305. A received signal input \overline{r}ₖ is provided to a non-inverting input of the adder 305. An output of the adder 305 is an error signal \overline{e}ₖ. The error signal \overline{e}ₖ is provided to a first input of a multiplier 306 and to a non-inverting input of an adder 309. An output of the amplifier 311 is provided to an input of a conjugate block 312. The amplifier 311 has a gain of −2. The conjugate block 312 performs a complex conjugate operation. An output of the conjugate block 312 is provided to a second input of the multiplier 306 and to a first input of a multiplier 310.

An output of the multiplier 306 is provided to an input of a transpose block 307, to a first input of a multiplier 313, and to a non-inverting input of an adder 314. An output of the transpose block 307 is provided to a second input of the multiplier 308, to a second input of a multiplier 313, and to a first input of a multiplier 315. An output of the multiplier 308 is provided to an inverting input of the adder 309. An output of the adder 309 is provided to a second input of the multiplier 310. An output of the multiplier 310 is provided to an inverting input of the adder 314. An output of the adder 314 is provided to a second input of the multiplier 315. An output of the multiplier 315 is provided to a denominator input of a divider 316. An output of the multiplier 313 is provided to a numerator input of the divider 316. An output of the divider 316 is provided to a second input of the multiplier 301.

Most of the arithmetic operations shown in FIG. 3 are vector operations. The output of the algorithm shown in FIG. 3 is a set of weights \overline{w}ₖ. The weights \overline{w}ₖ are provided to a filter, such as the filter 103 shown in FIG. 1, to produce the desired filtering of inputs to outputs.

Through the foregoing description and accompanying drawings, the present invention has been shown to have important advantages over the prior art. While the above detailed description has shown, described, and pointed out the fundamental novel features of the invention, it will be understood that various omissions and substitutions and changes in the form and details of the device illustrated may be made by those skilled in the art, without departing from the spirit of the invention. Therefore, the invention should be limited in its scope only by the following claims.

What is claimed is:

1. An adaptive filter comprising:
a configurable filter, a configuration of said configurable filter specified by one or more weights \overline{w}ₖ; and
a control algorithm, said control algorithm configured to compute a new set of weights \overline{w}ₖ₊₁ based on an adaptation factor αₖ multiplied by an estimated gradient \overline{g}ₖ at a point given by \overline{w}ₖ, where said adaptation factor is computed from said estimated gradient \overline{g}ₖ and an estimated gradient \overline{h}ₖ computed at a point \overline{y}ₖ, said point \overline{y}ₖ different from said point \overline{w}ₖ.

2. The adaptive filter of claim 1, wherein \overline{w}ₖ₊₁=\overline{w}ₖ−αₖ\overline{g}ₖ.

3. The adaptive filter of claim 1, wherein \overline{y}ₖ=\overline{w}ₖ−\overline{g}ₖ.

4. The adaptive filter of claim 1, wherein
$${α}_{k} = \frac{{\overline{g}}_{k}^{T} {\overline{g}}_{k}}{{\overline{g}}_{k}^{T} ( {\overline{g}}_{k} - {\overline{h}}_{k} )} .$$

5. A method for computing a new set of weights \overline{w}ₖ₊₁ in an adaptive filter comprising:
estimating a gradient \overline{g}ₖ at a point given by a current set of weights \overline{w}ₖ;
computing an adaptation factor αₖ where said adaptation factor is computed from said estimated gradient \overline{g}ₖ and an estimated gradient \overline{h}ₖ computed at a point \overline{y}ₖ, said point \overline{y}ₖ different from said point \overline{w}ₖ; and
computing \overline{w}ₖ₊₁ according to the equation \overline{w}ₖ₊₁=\overline{w}ₖ−αₖ\overline{g}ₖ.

6. The method of claim 5, wherein \overline{y}ₖ=\overline{w}ₖ−\overline{g}ₖ.

7. The method of claim 5, wherein
$${α}_{k} = \frac{{\overline{g}}_{k}^{T} {\overline{g}}_{k}}{{\overline{g}}_{k}^{T} ( {\overline{g}}_{k} - {\overline{h}}_{k} )} .$$

8. An adaptive filter comprising:
a configurable filter, a configuration of said configurable filter specified by one or more weights \overline{w}ₖ; and
means for computing a new set of weights \overline{w}ₖ₊₁ based on an adaptation factor αₖ multiplied by an estimated gradient \overline{g}ₖ at a point given by \overline{w}ₖ, where said adaptation factor is computed from said estimated gradient \overline{g}ₖ and an estimated gradient \overline{h}ₖ computed at a point \overline{y}ₖ, said point \overline{y}ₖ different from said point \overline{w}ₖ.
